(19) United States
(12) Patent Application Publication
(10) Pub. No.: US 2006/0291974 A1
(43) Pub. Date: Dec. 28, 2006

(54) Nut insert

(76) Inventors: Thomas McGee, South Lyon, MI (US); Frank Neri, Saugus, CA (US)

Correspondence Address: James M. Duncan, P.O. Box 11172, Bakersfield, CA, 93389-1172, US

(21) Appl. No.: 11/170,002

(22) Filed: Jun. 28, 2005

(51) Int. Cl. F16B 37/06

(52) U.S. Cl. 411/171; 411/183

(57) ABSTRACT

A nut insert which is installed within an aperture in a workpiece, the nut insert of the type in which a portion of the insert plastically deforms on the one side of the workpiece upon application of a linear force provided by a tool, thereby preventing withdrawal of the insert from the aperture. The nut insert comprises a sleeve member and an integral flange, where the flange has a larger diameter than the aperture, and the flange further comprises a contact surface for abutting the workpiece. The insert comprises fusible contact members which are adapted to fuse to the workpiece upon activation of the installation system, which includes current generation means.

### RELATED APPLICATIONS

Assignee hereto is also the assignee of currently pending application Ser. No. 10/698,975.

### BACKGROUND OF THE INVENTION

The present invention relates to an apparatus for attaching threaded fasteners to a workpiece, the workpiece having a first side and a second side. Usually the first side is a visible side and the second side is a blind side, meaning there is no access to the second side. More particularly, this invention relates to a nut insert which is used with an installation system which expands the body of the insert—such that the insert cannot be withdrawn from an aperture within the workpiece—while, nearly simultaneous to the expanding of the body of the insert, the system fuses a portion of the insert to the work piece. Appropriate fusing processes may include resistance welding and capacitor discharge welding.

It is known to use threaded rivet nuts, threaded inserts, and threadable inserts, as anchors for threaded fasteners in a number of different applications, including thin wall applications, such as sheet metal, which may be too thin to be tapped with threads. In many such cases there is access only to one side of the workpiece. In general, a hole is drilled or punched in the workpiece and the anchor device (i.e., the rivet nut, threaded insert, or threadable insert) is placed within the hole by an installation tool. With the known installation tools, when the tool is activated, a portion of the anchor device on one side of the workpiece (usually the blind side) is deformed to create an enlargement which prevents removing the nut insert from the hole. After the installation tool is remove, a threaded fastener may be inserted into a threaded portion of the insert.

Installation tools for setting nut inserts, particularly in blind applications, are known. These tools generally comprise a tool body (also referred to as an installation gun) from which extends a stud member having external threads. A pull rod is connected to the rear of the stud member, where the pull rod is connected to means within the tool body for reciprocating the stud member. The stud member typically extends through a nose piece which is connected to the front of the tool body. There are means within the tool body for rotating the stud member. An insert is screwed onto the external threads of the stud member, and the stud member made up into the insert until a flange on the end of the insert abuts the front end surface of the nose piece. The insert is thereafter placed within an aperture in the workpiece until the flange abuts the first side of the workpiece. The pull rod is then retracted rearwardly a predetermined stroke so as to expand a tubular portion of the insert which is on the second side of the workpiece. The linear force on the insert causes the sleeve of the insert to plastically deform, such that the expanded portion, sometimes referred to as the “bubble”, is larger than the diameter of the aperture, preventing withdrawal of the insert from the aperture. Examples of such tools may be found in U.S. Pat. Nos. 4,070,889; 4,368,631; 4,612,793; 4,574,612; 5,605,070; and 6,272,899.

It is desirable that the anchor device resist spinning or rotating within the aperture in the workpiece. One known means of preventing rotation of the anchor device within the hole of the workpiece is to make the hole in a shape other than round, such as octagonal, and to use an insert which has body having a corresponding shape, such that the body of the insert is locked within the hole to prevent rotation, as the corners of the body lock into corresponding corners of the hole. However, installing non-round openings in the workpiece and manufacturing inserts having other than a round shape is more costly than installing round openings in the workpiece and manufacturing round nut inserts.

### SUMMARY OF THE INVENTION

The present invention is directed to a nut insert to be used in combination with an insert installation system which meet the needs identified above. The disclosed apparatus is a nut insert which is installed within an aperture in a workpiece, the workpiece having a first side and a second side. The insert is the type in which a portion of the insert plastically deforms on the second side of the workpiece upon application of a linear force provided by a tool, thereby preventing withdrawal of the insert from the aperture. The nut insert comprises a sleeve member and an integral flange, where the flange has a larger diameter than the aperture, and the flange further comprises a contact surface for abutting the workpiece, the contact surface or other portions of the insert comprising fusible contact members adapted to fuse to the workpiece upon activation of the installation system. The nut insert may further comprise threads for receiving a threaded fastener. Alternatively, the sleeve may be threaded after the insert is installed within the workpiece.

The disclosed installation system, which has previously been described in a currently pending application owned by the assignee of the present application, performs two actions which may be performed in any order. The installation system causes the expansion of the sleeve and it also causes the fusible contact member to be fused or welded to the first side of the workpiece. The welded connection between the contact members and the workpiece prevents any rotation or spinning of the nut insert within the workpiece, and increases the integrity of the insert-fastener connection.

The installation system comprises an installation gun with a nose piece attached to the front of the gun. Insert attachment means extend through the nose piece of the tool body. Reciprocation means contained within the tool body are connected to the insert attachment means, which, by the application of linear force, cause the sleeve of the insert to plastically deform, as the insert attachment means is retracted within the nose piece into the tool body. A first electrode is attached to the nose piece. The system further comprises a second electrode for connecting to the workpiece. Current generation means are connected to the first electrode and the second electrode for creating an electrical current between the first electrode and the second electrode. The system comprises activation means for activating the reciprocation means and the current generation means.

Typically, a portion of the tool body, such as a threaded stud, provides the insert attachment means. The insert attachment means engages the sleeve member of the insert, such as by making up the threaded stud into internal threads within the sleeve of the insert. The insert is then placed within the aperture until the flange of the insert abuts the first side of the work piece, and the face of the nose piece abuts the flange on the other side. Upon activation, the reciprocation means connected to the insert attachment means causes the insert attachment means to be withdrawn into the tool body. At the same time, the nose piece of the installation tool, which abuts the flange of the insert, prevents movement of the flange. As the insert attachment means are reciprocated into the tool body and the insert is prevented from moving by the nose piece engaging the flange, a linear force is applied to the tubular sleeve of the insert on the second side of the workpiece, plastically deforming a portion of the sleeve into a bubble or secondary flange larger than the diameter of the hole in the workpiece. This bubble prevents withdrawal of the insert from the hole. The current generation means is activated either before or after formation of the bubble, fusing portions of the insert, such as the fusible contact members of the flange to the workpiece.

These and other features, aspects, and advantages of the present invention will become better understood with regard to the following description, appended claims, and accompanying drawings.

### BRIEF DESCRIPTION OF THE DRAWINGS

FIG. 1 is a first perspective view of an embodiment of the disclosed nut.

FIG. 2 is a second perspective view of the embodiment shown in FIG. 1.

FIG. 3 shows a quarter sectional view of an embodiment of the nut insert after being compressed and welded to the workpiece.

FIG. 4 is a first perspective view of another embodiment of the disclosed nut insert.

FIG. 5 is a second perspective view of the embodiment shown in FIG. 4.

FIG. 6 is a perspective view of another embodiment of the disclosed nut insert.

FIG. 7 is a side view of one variety of the disclosed installation system, shown installing a nut insert into a workpiece.

FIG. 8 shows the front section of a typical installation tool.

### DETAILED DESCRIPTION OF THE EMBODIMENTS

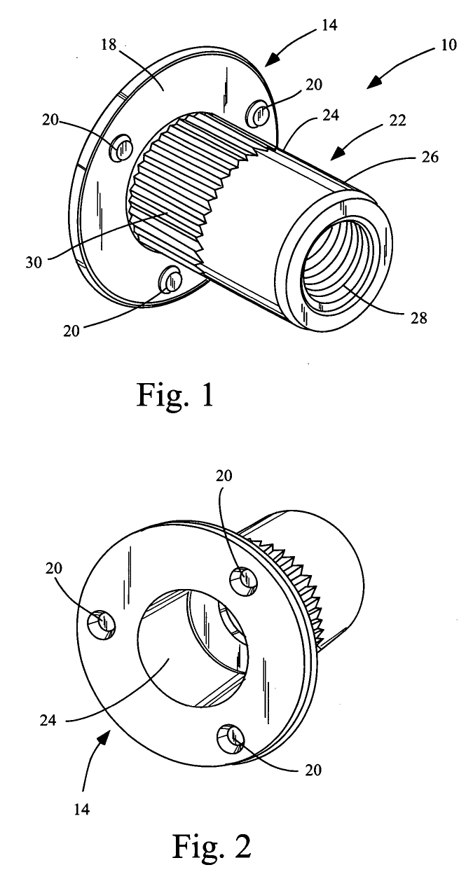

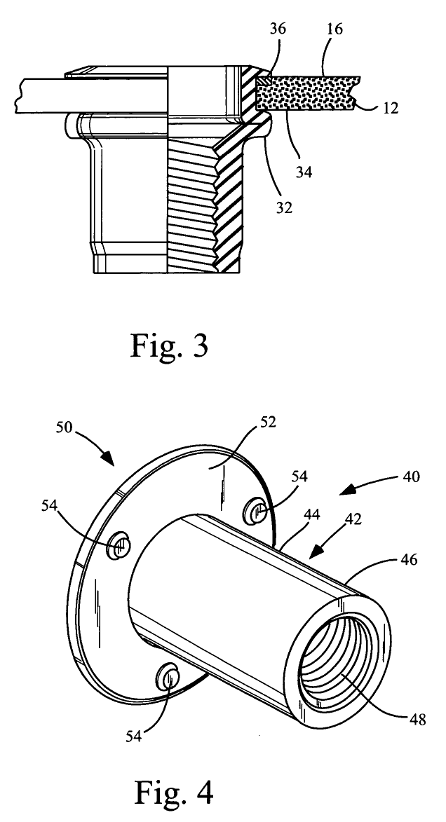

Referring now specifically to the drawings, FIG. 1 shows a perspective view of a first embodiment 10 of the disclosed nut insert as it appears before installing it within a workpiece 12 (shown in FIG. 3) prior to installation. Prior to installation of the nut insert the workpiece 12 will have been drilled, bored, or punched to create an aperture for insertion of one end of the nut insert. The embodiment 10 of the threaded insert depicted in FIG. 1 comprises a first flange 14 which is retained on the first side 16 of the workpiece 12. The first flange 14 further comprises a contact surface 18 which abuts the first side 16 of the workpiece 12. The contact surface 18 comprises one or more fusible contact members which are adapted to fuse to the workpiece 12 upon activation of the installation system. As shown in FIGS. 1 and 2, the fusible contact members may comprise material displaced from first flange 14 by punching first flange thereby creating a dimple 20 in the first flange as shown in FIG. 2.

This embodiment 10 further comprises a hollow sleeve 22 comprising a first section 24 which transitions into an axially adjacent second section 26. Second section 26 may also comprise threads 28, which are used to engage the threads of a corresponding fastener (not shown). Alternatively, second section 26 may be threaded after the nut insert is installed within the workpiece 12. First section 24 may further comprise knurls 30 in first section 24 to provide additional spin resistance within the aperture of workpiece 12.

As shown FIG. 2, first section 24 has a larger bore and therefore has a thinner wall thickness than the second section 26. The thinner wall thickness of first section 24 allows the first section to plastically deform upon the application of linear compression by the installation tool, resulting in the flowing of material to form bubble 32 as shown in FIG. 3. As shown in FIG. 3, bubble 32 abuts the second side 34 of workpiece 12, thereby preventing removal of the nut insert from the workpiece. FIG. 3 generally depicts the nut insert after activation of the installation tool. The fusible contact members form a fused or welded connection 36 between the nut insert and the work piece 12.

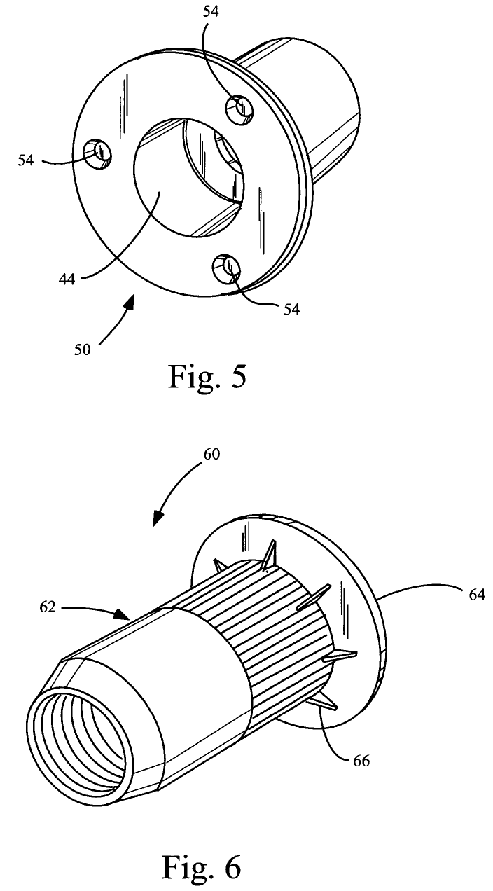

Another embodiment 40 of the threaded insert is shown in FIGS. 4 and 5. This embodiment 40 is essentially the same as the embodiment 10 shown in FIGS. 1 and 2, except the embodiment 40 shown in FIGS. 4 and 5 does not have knurls 28. The embodiment 40 shown in FIGS. 4 and 5 comprises a hollow sleeve 42 comprising a first section 44 which transitions into an axially adjacent second section 46. Second section 46 may also comprise threads 48, which are used to engage the threads of a corresponding fastener (not shown). Alternatively, second section 46 may have threads installed after the nut insert is installed within the workpiece 12.

Similar to the embodiment 10 shown in FIGS. 1 and 2, the embodiment 40 shown in FIGS. 4 and 5 comprises a first flange 50 which is retained on the first side 16 of the workpiece 12. The first flange 50 further comprises a contact surface 52 which abuts the first side 16 of the workpiece 12. The contact surface 52 comprises one or more fusible contact members which are adapted to fuse to the workpiece 12 upon activation of the installation system. As shown in FIGS. 3 and 4, the fusible contact members may comprise material displaced from first flange 50 by punching first flange thereby creating a dimple 54 in the first flange as shown in FIG. 2.

Another embodiment 60 is shown in FIG. 6. This embodiment 60 generally comprises hollow sleeve 62 and first flange 64. In this embodiment 60, instead of using the dimples 20 (and 54) of the other embodiments, the fusible contact members comprise wedges 66 on the underside of first flange 64. Other components of embodiment 60 are generally the same as the other embodiments discussed above.

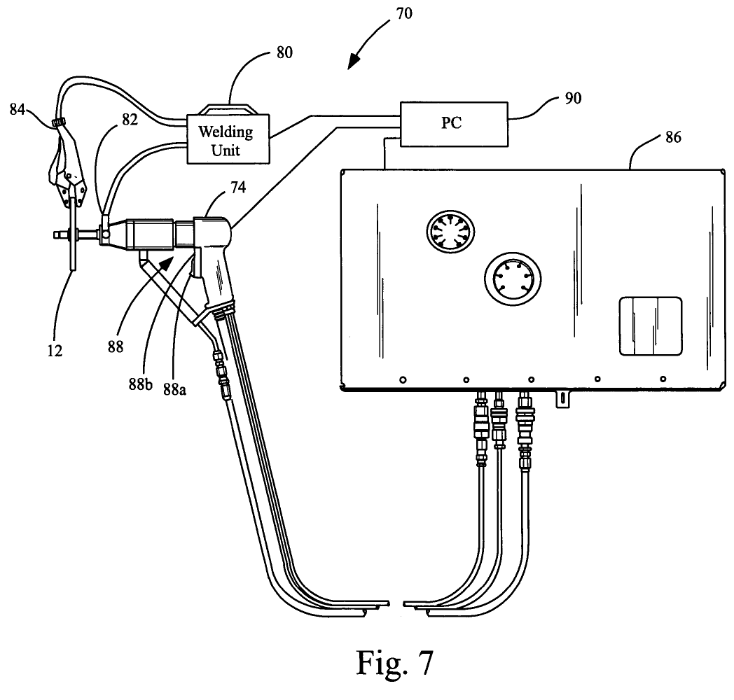

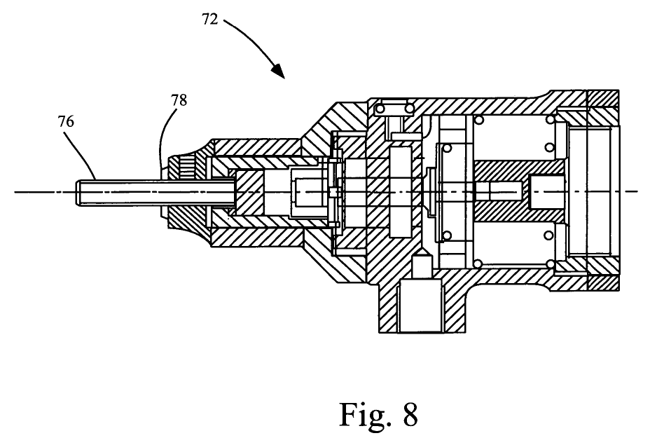

The different embodiments 10, 40, 60 are installed with an installation system 70 such as that depicted in FIG. 7. Installation system 70 comprises an installation gun 74, current generation means 80, a first electrode 82, a second electrode 84, and pneumatic operating means, such as air compressor 86. A detailed view of a typical front section 72 of an installation gun 74 is shown in FIG. 8.

The nut insert is spun onto insert attachment means, such as mandrel 76. Hollow sleeve 22 (or 42, 62) is placed within the aperture of the workpiece 12 until the first flange 14 (or 50, 64) is abutting the first side 16 of the workpiece 12, such that the first flange is sandwiched between the first side on one side and the nose piece 78 on the other. Upon activation of the current generation means 80, the fusible contact members are fused to the workpiece 12, forming one or more welded connections 36 between the insert 12 and the workpiece 14. The welded connection 36 prevents the installed nut insert from spinning within the workpiece, and provides a more secure anchor for a fastener installed within the insert.

Reciprocation means contained within the installation gun 74 act to either extend the mandrel 76 through the nose piece 78 to withdraw the mandrel into the body of the installation gun. As the mandrel 76 is withdrawn into the body of the installation gun 74, the nut insert 12 is prevented from moving by the nose piece 78 engaging the first flange 14 (or 50 or 64) of the nut insert. As the mandrel 76 is withdrawn into the installation gun 74, a portion of the hollow sleeve 22 (or 42 or 62) on the second side (or blind side) 34 of workpiece 12 is plastically deformed into a bubble 32 larger than the diameter of the hole in the workpiece. The bubble 32 prevents withdrawal of the nut from the hole in the workpieced 12.

As further shown in FIG. 7, a first electrode 82 is attached to nose piece 78 with fastening means, such as a bolt made up into matching threads in the nose piece. A second electrode 84 may connected to the workpiece 12 with clamping means, allowing for the second electrode to be quickly connected and released from the workpiece. The first electrode 82 and second electrode 84 are connected at their respective opposite ends to current generation means 80. The current generation means 80 may be activated nearly simultaneously with the activation of the reciprocation means, or may be activated either before or after activation of the reciprocation means. The current generation means 80 creates current flow between the first electrode 82 and the second electrode 84, causing a portion of the nut insert to be fused (i.e., welded) to the workpiece 12.

The reciprocation means may be powered by pneumatic operating means, such as air compressor 86. The installation system 70 further comprises activation means for activating the reciprocation means and the current generation means 80. As shown in FIG. 7, the activation means may comprise a trigger 88 attached to the installation gun 74. The installation system 70 may further comprise processing means, such as a programmable controller 90 which is capable of receiving input signals and generating output signals. Trigger 88 may be electrically connected to the programmable controller 90, such that activation of the trigger and opening or closing of the electrical contact initiates a command sequence by the programmable controller 90 with output signals being provided to various end devices.

For example, upon activation of the trigger 98, the programmable controller 90 might provide an output signal to the pneumatic control means, such as air compressor 86, to provide air pressure to the reciprocation means, thereby causing the hollow sleeve 22 of the nut insert to be plastically deformed to form bubble 32. Following a designated time interval, the programmable controller 90 may then provide an output signal to current generation means 80, causing a current to be applied between the first electrode 82 and the second electrode 84, causing the nut insert to be fused to the workpiece 12. Of course, this sequence may be reversed by simple changes in the logic of the programmable controller 90.

Alternatively, the installation system may comprise separate activation means respectively for the pneumatic control means and the current generation means. For example, a first trigger 88a may be used which activates the reciprocation means and a second trigger 88b which activates the current generation means 80. First trigger 88a and second trigger 88b may each respectively comprise a first electrical contact and a second electrical contact, each which either opens or closes upon manipulation of each of the triggers. The first electrical contact may then be electrically connected to the pneumatic control means, such that the pneumatic control means is activated when the first electrical contact is activated by manipulation of the trigger. Similarly, the second electrical contact may electrically connected to the current generation means 80, such that the current generation means is activated when the second electrical contact is either opened or closed upon manipulation of the trigger.

These and other features, aspects, and advantages of the present invention will become better understood with regard to the following description, appended claims, and accompanying drawings. While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A nut insert to be used in combination with an insert installation tool wherein the insert is disposed within an aperture in a workpiece, the nut insert of the type in which a portion of the insert plastically deforms upon activation of the insert installation tool thereby preventing withdrawal of the insert from the aperture, wherein the nut insert comprises:
a sleeve member having an integral flange, wherein the flange has a larger diameter than the aperture; and
fusible contact members adapted to fuse to the workpiece upon activation of current generation means connected to the installation tool.

2. The nut insert of claim 1 wherein the fusible contact members comprise one or more dimples in the integral flange.

3. The nut insert of claim 1 wherein the fusible contact members comprise one or more wedges on the underside of the integral flange.

4. The nut insert of claim 1 wherein the sleeve member comprises a first section and an axially adjacent second section.

5. The nut insert of claim 4 wherein the first section comprises knurls on the exterior.

6. The nut insert of claim 4 wherein the second section comprises internal threads.

7. A nut insert to be used in combination with an insert installation tool wherein the insert is disposed within an aperture in a workpiece, the nut insert of the type in which a portion of the insert plastically deforms upon activation of the insert installation tool thereby preventing withdrawal of the insert from the aperture, wherein the nut insert comprises:
a sleeve member comprises a first section and an axially adjacent second section;
an integral flange attached to the first section of the sleeve member, wherein the flange has a larger diameter than the aperture; and
fusible contact members attached to the integral flange, where the fusible contact members are adapted to fuse to the workpiece upon activation of current generation means connected to the installation tool.

8. The nut insert of claim 7 wherein the fusible contact members comprise one or more dimples in the integral flange.

9. The nut insert of claim 7 wherein the fusible contact members comprise one or more wedges on the underside of the integral flange.

10. The nut insert of claim 7 wherein the first section comprises knurls on the exterior.

11. The nut insert of claim 7 wherein the second section comprises internal threads.

12. A nut insert to be used in combination with an insert installation tool wherein the insert is disposed within an aperture in a workpiece, the nut insert of the type in which a portion of the insert plastically deforms upon activation of the insert installation tool thereby preventing withdrawal of the insert from the aperture, wherein the nut insert comprises:
a sleeve member comprises a first section and an axially adjacent second section;
an integral flange attached to the first section of the sleeve member, wherein the flange has a larger diameter than the aperture; and
fusible contact members attached to the integral flange, where the fusible contact members comprise dimples which are adapted to fuse to the workpiece upon activation of current generation means connected to the installation tool.

13. The nut insert of claim 12 wherein the first section comprises knurls on the exterior.

14. The nut insert of claim 12 wherein the second section comprises internal threads.
